(19) United States
(12) Patent Application Publication
(10) Pub. No.: US 2007/0259637 A1
(43) Pub. Date: Nov. 8, 2007

(54) RECORDING AND REPORTING OF DRIVING CHARACTERISTICS

(76) Inventors: Otman A. Basir, Waterloo (CA); David Bullock, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 11/745,063

(22) Filed: May 7, 2007

Related U.S. Application Data
(60) Provisional application No. 60/798,371, filed on May 5, 2006.

(51) Int. Cl. H04B 1/06

(52) U.S. Cl. 455/238.1

(57) ABSTRACT

A device and method for recording driving characteristics and for providing diagnostic information includes a cradle utilized for monitoring and compiling vehicle usage information for determining an insurance premium. The cradle is installed within a vehicle and connected to receive power from a vehicle power source. A memory device provides for the extraction of data gathered and stored within the cradle. Information from the cradle is uploaded to a central server that interprets the information and generates a summary and usage reports utilized to generate an insurance premium.

### CROSS REFERENCE TO RELATED APPLICATION

This application claims priority to U.S. Provisional Application No. 60/798,371 which was filed on May 5, 2006.

### BACKGROUND OF THE INVENTION

This invention relates to a device and method for recording driving characteristics and diagnosing a condition of the device. More particularly, this invention relates to a method and device for recording driving characteristics utilized to monitor and compile vehicle usage data and diagnosing device condition for determining an insurance premium.

Vehicle insurance is currently determined substantially through the use of historical data combined with information from other sources concerning the vehicle owner and operator. The information concerning the operator typically includes general vehicle usage information such as how the operator typically uses the vehicle, such as for going back and forth to work. The locations, time and speed in which the vehicle is utilized by the operator are also considered in the determination of the vehicle insurance premium.

A principal disadvantages with this method of insurance premium determination is that much of this information is not verifiable. In other words, an operator may exaggerate or under estimate the actual usage of the vehicle. Accordingly, an insurance provider is therefore at a disadvantage in applying a premium based on predicted or non-verifiable information. Some of these instances can be corrected through the periodic updating of information through available driving records such as available from state and local governments to reveal driving violations or accidents.

However, in the absence of such data the actual operating characteristics and use of a vehicle are not easily determinable. Accordingly, the insurance provider relies on the operator provided information.

Accordingly, it would be beneficial to develop a process and device for installation within a vehicle that could easily gather useful data that can be utilized for the determination of insurance premiums based on actual vehicle use.

### SUMMARY OF THE INVENTION

An example device and method for recording driving characteristics and for providing diagnostic information includes a cradle utilized for monitoring and compiling vehicle usage information for determining an insurance premium.

An example disclosed system includes a cradle for installation within a vehicle and connected to receive power from a vehicle power source. A memory device provides for the extraction of data gathered and stored within the cradle. Information from the cradle is uploaded to a central server that interprets the information and generates summary and usage reports utilized to generate an insurance premium. Further, other example features provide for the direct uploading of vehicle usage information through an established wireless link.

The example cradle includes a memory module, a power module, a location module and a sensor module. Each of these modules is in communication with a microprocessor. The example power module is connected to an always-on vehicle power source. Further, the example power module includes a rechargeable battery for operation in circumstances where vehicle power is not provided to the cradle. The example sensor module includes an accelerometer, a real time clock, and a vibration sensor that provide an indication as to whether the vehicle is moving. The localization module includes a global positioning system module for determining a location based on signals received from various satellites

The example cradle and method of communicating information disclosed provides a manageable, usable and simple method for obtaining vehicle usage information and for use in determining and verifying vehicle operating conditions.

The features of the present invention can be best understood from the following specification and drawings, the following of which is a brief description.

### BRIEF DESCRIPTION OF THE DRAWINGS

FIG. 1 is a schematic representation of an example system and process for gathering vehicle usage data.

FIG. 2 is a block diagram of an example device for gathering and compiling vehicle usage data.

FIG. 3 is a block diagram of another example device gathering and compiling vehicle usage data.

FIG. 4 is a graphical illustration of an example map illustrating a percentage of time that a vehicle is operated within a specific geographic region.

FIG. 5 is a graphical illustration of an example map illustrating a velocity that a vehicle traveled over specific routes.

### DETAILED DESCRIPTION OF THE PREFERRED EMBODIMENT

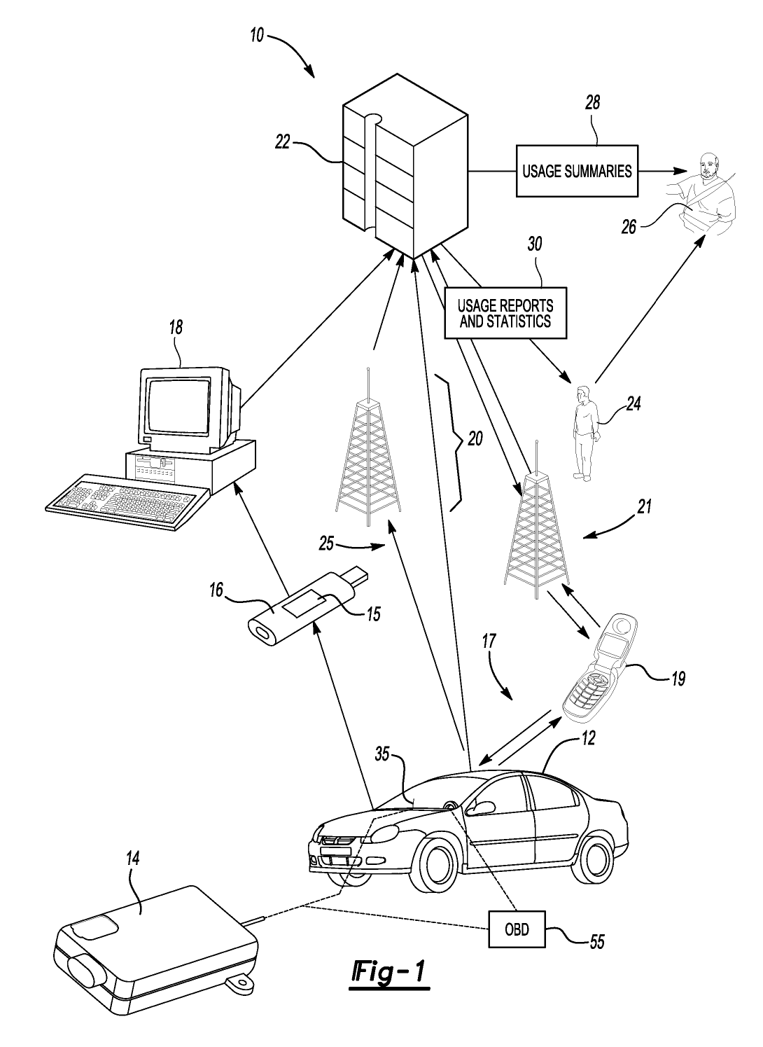

Referring to FIG. 1, a schematic representation of the system 10 is shown and includes a cradle 14 for installation within a vehicle 12. The cradle 14 is installed within the vehicle 12 preferably in a location that is easily accessible yet not in plain view such as to cause an obstruction to the operator. Preferably, the cradle 14 will be installed underneath an instrument panel or within a glove compartment. The cradle 14 is attached and connected to receive power from a vehicle power source. Power from the vehicle can originate from a non-switched fuse box, OBD-II port, or other powered connection within the vehicle 12 as known.

A memory device provides for the extraction of data gathered and stored within the cradle 14. The memory device illustrated is a USB data key 16 that is insertable and removable from the cradle 14. The USB data key 16 receives information that is compiled from the cradle 14 for subsequent analysis. In the example embodiment, the USB data key 16 is removed and communicates with a personal computer 18. The vehicle user removes the USB data key 16 in response to a triggering event such as a lapse of time and downloads the information into the personal computer 18. The information is then transmitted via the Internet or other data communication link to a central server 22. The central server 22 interprets the information and generates summary 28 and usage reports 30.

The summary 28 may be reviewed by an operator 26 and insurance provider 24 and can contain any desired combination of information gathered by the cradle 14. The reports 30 for the insurance provider may include more directed and focused usage information directly focused for determining an insurance premium tailored to the specific operator 26. The data key 16 may also include a microprocessor 15 that enables separate execution of software instructions independent of a personal computer 18.

The data key 16 can include a code or other instructions that pairs the data key 16 with a specific vehicle 12 or with the specific cradle 14 disposed within the vehicle. The paired nature of the data key 16 to the cradle 14 provides for the prevention of unauthorized use or download of information from other data keys from other vehicles.

Each of the data key 16 and the cradle 14 includes an identification code or serial number. During initialization of the cradle 14 and the data key 16, the data key 16 stores the identification code of the data key 16 and the cradle stores the identification code of the data key 16. Once the data key 16 and the cradle 14 have exchanged information or have been “married”, neither the data key 16 nor the cradle 14 can operate with another device. The data key 16 and the cradle 14 are set as “married”. This paired nature between the data key 16 safeguards against attempts to modify data that is gathered that may not be indicative of use of the specific vehicle 12.

In the event that a second data key 16 that is married to second cradle 14 is inserted into this first cradle 14, nothing will be transferred to the data key 16, except an identifier flag that indicates the attempted pairing with another non-paired cradle.

In the event that a data key 16 is lost and requires replacement, a new data key that is set to a “single” setting can be mated with the cradle 14. The cradle 14 will then replace the old identification code of the lost data key with the new identification of the new data key 16. The new data key 16 does the same and also is reset to a “married” setting. Once the data key 16 and cradle 14 are set to the “married” setting indicating that it has been paired, no other data key 16 or cradle 14 will be compatible with the pair. Even if the lost data key is found, it cannot be utilized with the cradle 14, as that keys identification code has been replaced with the identification code of the new data key 16.

Once the cradle 14 is moved to the “married” setting in cannot be reset to a “single” setting by a user. Further, once the data key 16 has been reset to the “married” setting it cannot be reset to the “single” setting that allows pairing with other cradles 14. This prevents unauthorized and uncontrolled swapping of data keys 16 with various cradles 14 that can skew information.

Data that is saved to the data key 16 is encrypted to prevent the unauthorized modification by a user or other individual. The encrypting is provided to prevent modification of any data stored on the data key 16 such that data stored on the data key 16 can be assured to be actual data indicative of vehicle operation. The data key 16 includes programming that provides information and programming that can discern whether the data key 16 is connected to the cradle 14 within the vehicle or that it is connected to a personal computer 18. If connected to a personal computer 18, programming and encryption prevent unauthorized manipulation of stored data.

FIG. 1 shows an example transmission method where the cradle 14 directly transmits by way of a wireless link 20 to the central server 22. This provides for the automatic transmission of data indicative of vehicle usage directly to the central server 22 without requiring operator intervention or action. Such a wireless transmission link streamlines data acquisition and processing at the central server 22. Further, automatic and direct transmission of vehicle usage information can substantially eliminate potential data integrity and verification issues that may arise with the involvement of the operator 26.

Another means for communicating information gathered by the cradle 14 to the central server 22 is through a Bluetooth connection 17 with a cellular communication device, such as for example a phone 19. The Bluetooth connection 17 between the phone 19 and the cradle 14 facilitates communication through a cellular phone network 21 to the central server 22. The phone 19 includes a resident program that directs the receipt and forwarding of data from the cradle 14 to the central server through the Bluetooth connection 17.

The wireless link may also include a connection by way of a local area WiFi link 25 as is known. The wireless link can include any known low frequency transmission format. Further, the path of the transmission may include other paths as are known, not simply those that are illustrated. As appreciated, many different wireless networks or methods of utilizing wireless networks can be utilized to upload vehicle operation data.

Further, the cradle 14 includes software that can be updated by the data key 16. The data key 16 is in communication with the central server 22 that provides periodic communication and software updates. The periodic communications to the data key 16 can include simple status information or can also be utilized to update any programming stored on the cradle 14. Such programming updates are sent by way of the wireless link 20 or the personal computer 18 from the central server 22 to the data key 16. If the data key 16 is connected to the cradle 14, the software or program update can occur automatically. If the data key 16 is not connected to the cradle 14, the programming updates can be stored in the data key 16 for latter download upon the next connection of the cradle 14. Alternatively, the desired software update can simply be delayed until such time as the data key 16 is mounted to the cradle 14.

As appreciated, the data key 16 will be mounted to the cradle 14 during most vehicle operating conditions. The removal of the data key 16 is typically only for the transfer and download of data to the central server 22. During periods where the data key 16 is not mounted to the cradle 14, data is stored in the cradle 14. Upon subsequent connection of the data key 16 to the cradle 14, data can be downloaded to the data key 16.

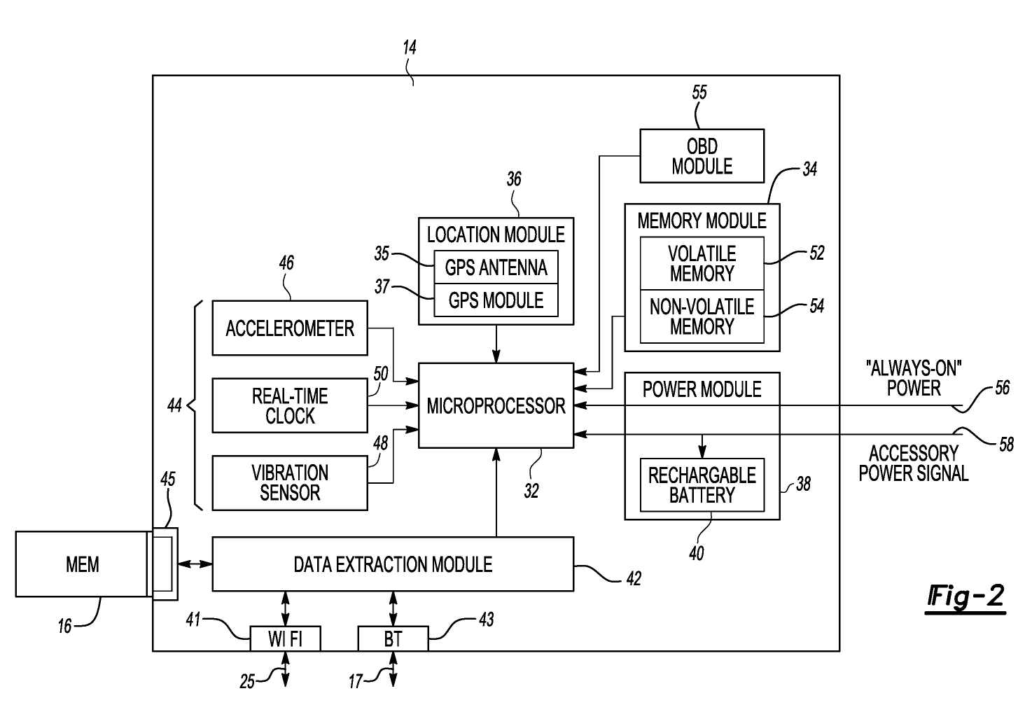

Referring to FIG. 2, the cradle 14 is shown schematically and includes a memory module 34, a power module 40, a location module 36 and a sensor module 44. Each of these modules is in communication with a microprocessor 32. The microprocessor 32 communicates with the various modules to receive data and other information as required.

The memory module 34 includes a volatile memory 52 and a non-volatile memory 54. Data is stored in the memory module 34 as directed by the microprocessor 32 until transmission to the central server 22.

The power module 40 is preferably connected to an always-on vehicle power source 56. Further, the power module includes a connection to an accessory power signal 58 that provides an indication that the vehicle ignition is on. The cradle 14 is powered by power from the vehicle 12. The power module 38 includes a rechargeable battery 40 for operation in circumstances where vehicle power is not provided to the cradle 14. This allows the cradle 14 to operate in some capacity when the vehicle power source is not properly providing power.

The power module 38 provides continuous main power from the vehicle's main battery source. In the disclosed example, power is accessed from a non-switched fuse panel, OBD-II or other vehicle power connection location. To ensure that during periods when power is disconnected, the rechargeable battery 40 is able to maintain system critical functionality. In other words, some power is always provided to the cradle 14 such that minimal functions can always be performed. As appreciated, although a rechargeable battery 40 is shown and described, standard non-rechargeable batteries are also within the contemplation for use in providing an alternate and independent power supply to the cradle 14.

The sensor module 44 includes an accelerometer 46 for determining an acceleration or deceleration of the vehicle 12. The accelerometer is preferably capable of measuring acceleration in three axes; however, any accelerometer known in the art is within the contemplation of this invention. Measuring acceleration provides a good indication of driving habits of the operator 26. Frequent hard braking and hard acceleration can be indicators of operator driving habits. Further, hard cornering is also detected by the accelerometer 46 and provides information indicative of an operator's driving habits.

A real time clock 50 provides the time for several purposes including providing a determination of the time of day in which the vehicle is operating. The clock 50 allows the determination of trends of vehicle usage. Further, the clock 50 is utilized to determined the amount of time the vehicle is used, per-day and over the enter data acquisition period.

The vibration sensor 48 provides an indication as to whether the vehicle is moving or not in the absence of power from the vehicle itself. This provides a validation function to determine if the lack of power from the vehicle is truly indicative of the vehicle not operating or if the vehicle is moving without powering the cradle 14.

The localization module 36 includes an antenna 35 and a global positioning system module 37. The antenna 35 receives signals from satellites to determine a location of the cradle 14, and thereby the vehicle with regard to a specific longitude and latitude. The position information provides for the determination of the places in which the vehicle is being utilized. Positional information provides for the determination of several valuable types of information including time within a specific geographic region in which a vehicle is operating. Further, the location module provides information that is utilized to determine how much time a vehicle is used within a specific defined region such as a postal code, city or town limit. The system may even provide information as to the type of road the vehicle is used on, for example surface streets or on an expressway.

The GPS module 37 also provides an alternate means of gathering vehicle acceleration information in the absence of data from the accelerometer. The positional information provided by the GPS module 37 over time provides for the determination of vehicle acceleration in two axes in the event that the sensor module 44 and thereby information from the accelerometer 46 is not available. Additionally, acquisition of time measurements can be facilitated through the GPS module 37 in the event that communication with the real time clock 50 is not available.

The Bluetooth connection 17 is alternatively utilized in concert with the GPS module 37 to provide a means of remotely obtaining location information of the vehicle. The central server 22 can call the phone 19 associated with the cradle 14 and upload location information obtained by the GPS module 37. The upload of location information can be triggered remotely by the central server 22 by contacting the phone 19 that in turn through the Bluetooth 17 link will obtain information on the location of the vehicle. This information is then communicated back over the cellular connection 21 to the central server 22. Further, the communication between the phone 17, the central server 22 and the cradle 14 provides for real-time location and tracking of a vehicle. The real-time tracking can be triggered according to a desired schedule, or in response to a specific triggering event.

Further, the resident program within the phone 17 can be utilized to periodically trigger communication as desired to provide an alternate method of uploading information from the cradle 14 to the central server 22. An operator can be provided with the option to accept or reject communication. Such communication can also be delayed to provide for operation of the phone by the operator as desired. As appreciated, many different triggering events and schedules can be instituted utilizing the Bluetooth communication link 17 to provide desired data on vehicle operation and location.

The cradle 14 includes instructions that are utilized in the event of a blackout of the GPS system. As appreciated, some areas or other conditions may be blacked out from GPS signals required to determine a position. An example embodiment includes provisions for compensating for such blackouts. During such a blackout the cradle utilizes the last known GPS position along with speed and direction data gathered from other system to determine a general location. The general location determined independent of the GPS system is not as accurate, but can provide information as to the general geographic location. The general geographic location is determined from the available vehicle information that is indicative of vehicle direction and speed. As appreciated, such a system can be utilized when the geographic nature of the area such as a tunnel or mountains prevent a clear GPS signal.

Further, the vehicle speed and direction information can be utilized in conjunction with the next GPS signal such that the path of the vehicle 12 can be orientated utilizing the two separate GPS signals along with the intervening information indicative of vehicle speed and direction.

The cradle 14 includes a data extraction module 42 for the transmission and removal of data from the cradle 14. The example data extraction module 42 includes a USB port 45 for communication with a removable data storage device such as the USB key 16. The example data extraction module 42 may also comprise a wireless transmission device for sending a transmission to a receiver station and subsequently to the central server 22.

The wireless communication can include a wireless USB, an infrared signal or other known wireless transmission device. The data extraction module 42 may also include a carrier based wireless transmission device. The example data extraction module 42 communicates with a WiFi module 25 for communicating information to a WiFi network. Further, the data extraction module 42 can include a peer-to-peer wireless transmission where an intermediate receiver station receives the peer-to-pear communication and passes it onto the central server 22 by a wireless or wired connection. The data extraction module 42 is also in communication with a Bluetooth module 17 for communicating with other Bluetooth enabled devices. Further, communication can then be enabled through a Bluetooth device such as the phone 19 through a cellular communications network 21.

The data extraction module 42 may also comprise a data modem transmission device that is attachable to a download station. The data extraction module 42 would comprise in such an embodiment a serial or other connection interface for attachment to a modem or other known connection or port.

The microprocessor 32 chooses among the various devices (e.g. data key 16, WiFi, Bluetooth, GPRS, etc) for communicating the vehicle operating data according to a prioritization that reflects both the different “costs” of using each the different devices and the “urgency” of communicating the vehicle operating data at the time. For example, the “cost” of using the data key 16 reflects the effort that must be expended by the user. The cost of using Wifi and Bluetooth could reflect associated actual per-minute charges that might be associated with using these devices, which could vary based upon time of day and day of the week, and might also reflect any potential security risks posed by using these devices.

Additionally, the “urgency” of communicating the vehicle operating data would increase as the time elapsed since the last upload increases. Also, the “urgency” might be increased to the extent that the vehicle operating data to be uploaded differs from the typical vehicle operating data normally experienced by that vehicle (in terms of locations, speed, driving habits, etc). “Urgency” would be high in the event of a vehicle maintenance issue, and very high in the event of an accident.

Based upon the current “urgency” of uploading the data, the “costs” associated with the different devices and based upon what devices are currently able to provide a link to the server 22 (i.e. is WiFi available? Is a Bluetooth internet connection available?), the microprocessor 32 chooses the appropriate method for communicating the vehicle operating data to the server 22. The priority rules may be set or modified by the user using the personal computer 18 and transmitted to the microprocessor 32 via the data key 16 or over the internet

The data extraction module 42 may also comprise a data display for an encoding an alphanumeric string. The alphanumeric string would be displayed on a digital display panel of a device. The encoded string could then be transmitted to the central server 22 through a number of methods including and not limited to the Internet, telephone or by mail. The data extraction module 42 would display an alpha numeric code utilized to determine if any events had occurred during the data-gathering period that would affect the insurance premium for the specific vehicle.

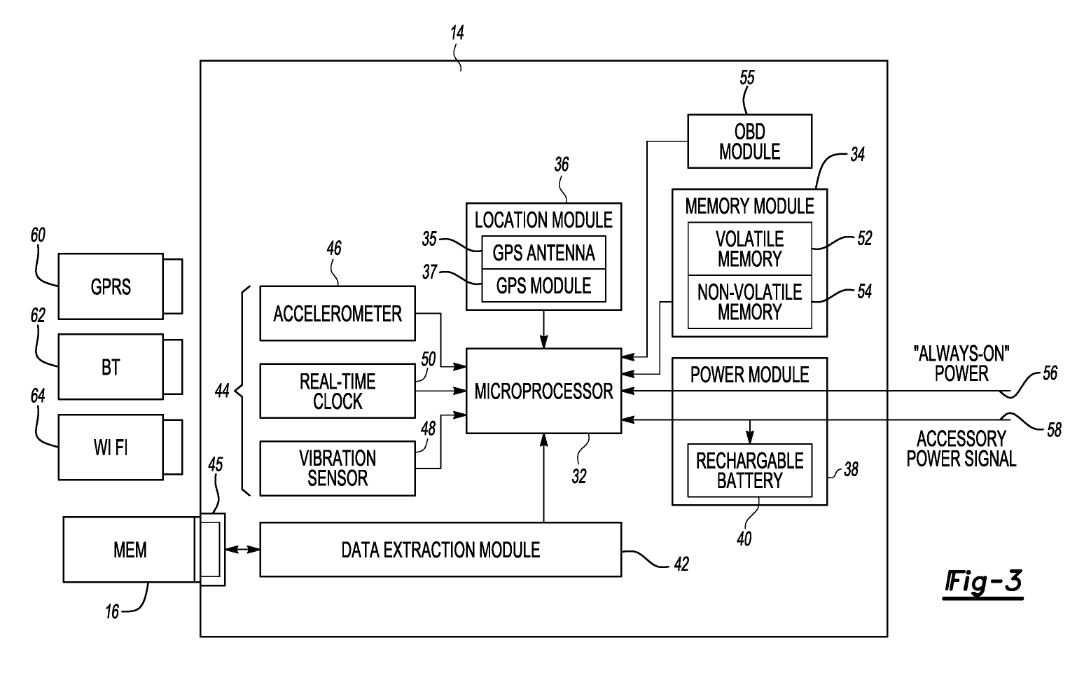

Referring to FIG. 3, another example cradle 14A includes a data extraction module 42A with only the USB port 45. The USB port 45 can accept various modules along with the data key 16. The various modules can include a WiFi module 64, a Bluetooth module 62 and a general packet radio signal (GPRS module 60. A user determines the method of transmitting or uploading data by the type of module plugged into the USB port 45. Accordingly, plugging in the GPRS module 60 provides for the transmission of data through an applicable wireless link. Similarly, the Bluetooth module 62 and WiFi modules 64 plugged into the USB ports 45 provide different wireless links for receiving and uploading data.

Once data has been extracted from the cradle 14 it may be viewable through the personal computer 18. Typically, viewing on a personal computer 18 is accomplished by utilizing the data key 16. The information once downloaded from the data key 16 via the personal computer 18 could then be transmitted to the central server 22 where the data could be compiled for viewing and a determination of insurance premiums. Further, initial viewing of information on the personal computer 18 would afford a user an opportunity to review the data prior to submission to an insurance provider. The operator could then determine if the data is indicative of actual vehicle usage and if submission of the data would be beneficial to the user for reducing insurance premiums.

Another use of the gathered data by a user at the personal computer 18 is to analyze vehicle operating parameters and performance such as fuel mileage, performance, braking operation and driving performance. As appreciated, the fuel mileage is easily determined by providing information indicative of current and actual fuel levels 14. This information can be utilized by an operator or fleet manager to determine and monitor operation of the vehicle.

In the example embodiment, data is extracted from the cradle 14 and transmitted to the central server 22 by way of the USB key 16 and personal computer 18. Once the data is extracted and transmitted to the central server 22, this data can be consolidated into reports and summaries for the user and insurance provider.

During normal operation the localization module 36 provides vehicle position in longitude and latitude. The vehicle position is utilized to determine vehicle heading, speed and other information indicative of a vehicle position. Further, combination of the known longitude and latitude of the vehicle with geographic divisions such as postal codes, zip codes, governmental division such as cities or towns can be utilized to determine the amount of usage of a vehicle within a given area. As is appreciated insurance premiums are based in large part on the actual time, location and operation of the vehicle.

The use of the localization module 36 provides a means for gathering meaningful data on the time, position and operating location of a vehicle. The operational position of a vehicle can be correlated with geographic limits to determine a time in each of the divisions.

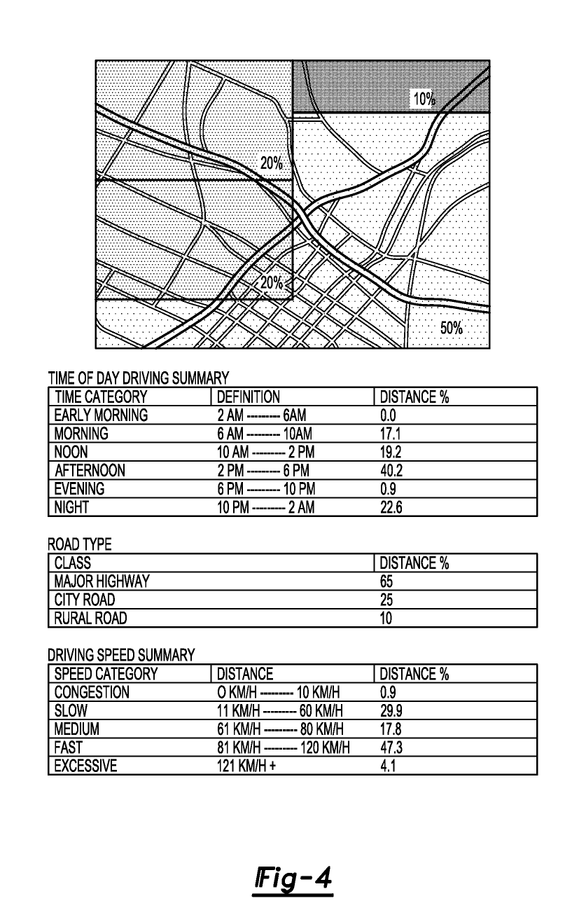

Referring to FIG. 4, information on vehicle location and speed can be displayed on an applicable map according to a certain percentage of the operating duration within a specific zip code or other geographic designation. In this example, the percent of time related to the total time information was gathered that a vehicle was in designated geographic region is mapped. This provides information that can be utilized in determining an appropriate insurance premium. Additionally, with further correlation a combination with known geographic limits the vehicle operation with regard to use on an expressway or surface street can be determined. Data gathered utilizing the geographic location can be displayed in many different formats such as color coded maps that not only illustrate position by also provide information on vehicle operating conditions.

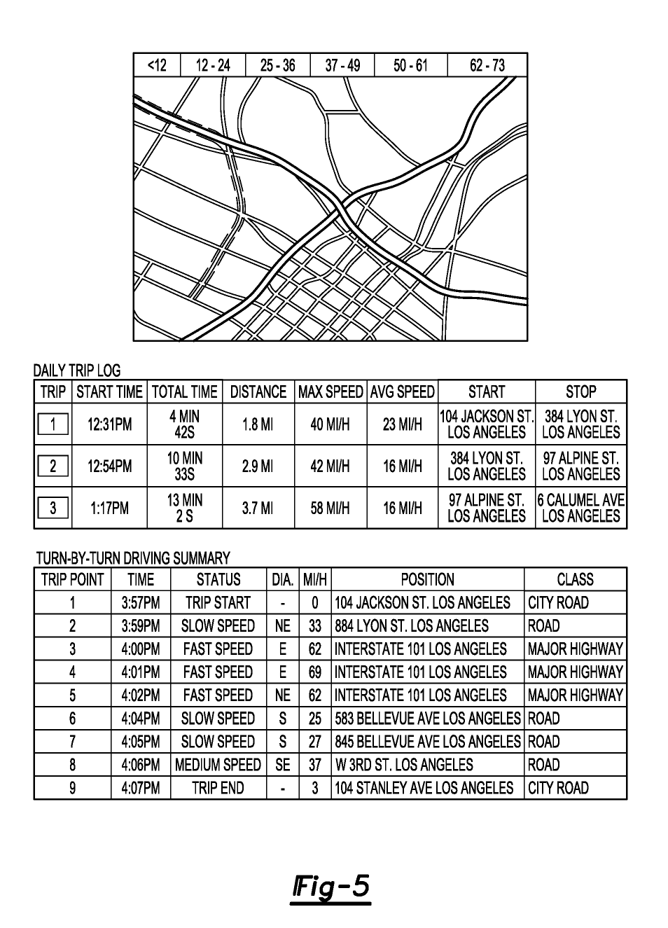

Referring to FIG. 5, vehicle speed along specific routes can be illustrated on an appropriate map. In this example, speed within a specified range is differentiated by different markings on the applicable route. Further, color coding or other identifying markings could be utilized to easily identify the speed at which a vehicle was operated over the designated routes. As appreciated, the format and display of the data gathered indicative of vehicle location and speed can be manipulated to illustrate any desired parameter of vehicle operation recorded by the cradle 14.

The geographic limits and segmentation are applied to the latitude and longitude data either at the central server 22 or in the cradle 14 itself. Depending on the detail desired for determination of the geographic limits, the application of postal code conversions are performed at the central server 22. In some instances, generalized and less detailed geographic applications can be performed by the cradle 14 to provide local processing of specifically desired geographic data.

Referring to FIGS. 2 and 3, other existing vehicle sensors can be connected to the cradle 14 to provide additional information. Current vehicles can include an on-board diagnostic device (OBD) that monitor vehicle system and communicates that information for use to diagnose potential or actual vehicle operating problems. The OBD module 55 is in communication with the cradle 14 to pass along information indicative of current vehicle condition. The OBD module 55 is either in wireless communication through a wireless link, or hard wired to directly communicate information to the cradle 14. The OBD module 55 is queried by the cradle 14 to gather vehicle operating information such as current fault conditions, or other conditions of interest for the determination and monitoring of vehicle operating conditions. Further, the OBD module 55 will communicate the activation of emergency restraint systems so that that event can be stored. Further, as the cradle 14 can be in wireless communication with a wireless network 20, any activation of vehicle emergency systems can be immediately communicated to the central server 22 where emergency assistance can be alerted and directed to the location of the vehicle to aid vehicle occupants.

The cradle 14 and method of this invention provides a manageable, usable and simple method for obtaining vehicle usage information for use in determining and verifying vehicle operating conditions.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of recording vehicle usage comprising the steps of:
a) sensing data indicative of a vehicle operation characteristic, including a location of the vehicle;
b) storing sensed date indicative of the vehicle operating characteristic in a memory module; and
c) uploading the stored data indicative of vehicle operating characteristics including location of the vehicle to a server responsive to a desired triggering event.

2. The method as recited in claim 1, including the step of pairing a data key with a cradle mounted within a specific vehicle and the step of uploading data includes uploading data indicative of vehicle operation to the data key.

3. The method as recited in claim 2, wherein the step of pairing the data key with the cradle mounted within the specific vehicle includes the step of preventing data upload from any other than the paired cradle mounted within a specific vehicle.

4. The method as recited in claim 3, including the step of encrypting data uploaded onto the data key to prevent unauthorized manipulation.

5. The method as recited in claim 2, including the step of diagnosing cradle operation and storing data indicative of operating characteristics of the cradle.

6. The method as recited in claim 2, including the step of uploading data within the data key to a central server.

7. The method as recited in claim 2, including the step of downloading information from a central server to the data key for transfer to the cradle.

8. The method as recited in claim 7, including updating cradle operating instructions through transfer of information from the data key.

9. The method as recited in claim 1, including the step of establishing a wireless communication link with a portable communication device disposed proximate the vehicle, and uploading the data indicative of the vehicle operation characteristic, including a location of the vehicle to the portable communication device.

10. The method as recited in claim 9, including the step of communicating data indicative of the vehicle operation characteristic, including a location of the vehicle from the portable communication device through a cellular communication network to a central server.

11. The method as recited in claim 10, including sending instructions from a central server through a cellular communication network to the portable communication device and from the portable communication device to the cradle through the established wireless communication link.

12. The method as recited in claim 9, including instructing the cradle to forward vehicle location information to the central server through the wireless communication link.

13. The method as recited in claim 2, including the step of communicating between the cradle and a vehicle on board diagnostic device, and forwarding data from the vehicle on board diagnostic device to a central server.

14. A cradle device for gathering vehicle usage data for use in determining vehicle insurance cost comprising:
a memory module for storing data indicative of vehicle operating characteristics;
a first receiver for receiving satellite signals indicative of a vehicle position;
a power module including a connection to an external power source, and an internal power source for powering said device independent of the external power source;
a first sensor for detecting motion of said device; and
a controller for aggregating data stored within said memory module responsive to a triggering event.

15. The cradle device as recited in claim 14, including a removable data key for extracting data, wherein the removable data key is mated for use only with a single identified cradle device.

16. The cradle device as recited in claim 14, wherein said first sensor comprises an accelerometer for sensing an acceleration of a vehicle.

17. The cradle device as recited in claim 14, wherein said first sensor comprises a vibration sensor for sensing motion of the vehicle.

18. The cradle device as recited in claim 14, including a second receiver for establishing a wireless link to a cellular communication device.

19. The cradle device as recited in claim 18, wherein the wireless link comprises a Bluetooth wireless communication link.
